(19) United States
(12) Patent Application Publication
(10) Pub. No.: US 2009/0174237 A1
(43) Pub. Date: Jul. 9, 2009

(54) Bicycle seat adjustable device

(76) Inventor: Chao-Hu Chen, Shengang township (TW)

Correspondence Address: Chien-Hui Su, P. O. Box 70-121 Taichung, Taichung City, 40899, TW

(21) Appl. No.: 12/007,057

(22) Filed: Jan. 7, 2008

(51) Int. Cl. B62J 1/02

(52) U.S. Cl. 297/215.13

(57) ABSTRACT

A bicycle seat adjustable device includes a seat post connected to a seat tube and a transverse tube is connected on a top end of the seat post which including a passage. Two notches are defined radially in two inner peripheries of two open ends of the transverse tube respectively. Two adjustable members each have a tubular portion inserted into the passage via the open end corresponding thereto. One of the adjustable members has an adjustable bolt extending from one end thereof and is threadedly connected to the other adjustable member. Each adjustable member has a protrusion extending outward and radially therefrom and is engaged with the one of the two notches of the transverse tube so as to restrict the pivotable movement of the two adjustable members. Two rails of the seat are clamped between two open ends of the transverse tube and the two adjustable members.

### FIELD OF THE INVENTION

The present invention relates to a bicycle seat adjustable device and the device prevent the seat from overly pivoting relative to the seat tube.

### BACKGROUND OF THE INVENTION

A conventional seat is connected to a seat post which is securely inserted into the seat tube. The seat generally includes two rails at the underside of the seat the rails are clamped by a seat adjustable device on the seat post. The seat is designed to be pivotable relative to the seat tube so as to meet different requirements of different riders. Generally, the two rails are clamped by the securing units of the seat adjustable device and there is no proper mechanism to prevent the seat from overly pivoted if the clamping force fails to function. If the seat suddenly loosened and pivoted, the rider will lose his balance and the rider's body turns and affects control of the bicycle. This un-expect situation may lead to a dangerous result.

The present invention intends to provide a bicycle seat adjustable device which includes two notches in two open ends of the transverse tube and the two adjustable members each have a protrusion restricted in the notches. The two rails of the seat are clamped by the transverse tube and the two adjustable members so that when the seat is pivoted, the notches restrict the pivoting angle of the seat.

### SUMMARY OF THE INVENTION

The present invention relates to a bicycle seat adjustable device and comprises a seat post connected to a seat tube and a transverse tube is connected on a top end of the seat post. The transverse tube includes a passage and two open ends which communicate with the passage. Two notches are defined radially in respective two inner peripheries of the two open ends respectively. Two adjustable members are connected to the two open ends of the transverse tube and each of the two adjustable members has a tubular portion which is inserted into the passage via the open end corresponding thereto. One of the adjustable members includes an adjustable bolt extending from one end thereof and the adjustable bolt is threadedly connected to a threaded hole in the other adjustable member so as to move the two adjustable members toward each other by rotating the adjustable bolt. Each adjustable member has a protrusion extending outward and radially therefrom and engaged with the one of the two notches of the transverse tube. Two rails are clamped between two open ends of the transverse tube and the two adjustable members.

The primary object of the present invention is to provide a bicycle seat adjustable device that securely positions the seat and the seat is prevented from overly pivoting relative to the seat post.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bicycle seat adjustable device of the present invention;

FIG. 2 is a perspective view to show the bicycle seat adjustable device of the present invention;

FIG. 3 is a partial cross sectional view to show the bicycle seat adjustable device of the present invention;

FIG. 4 is a partial cross sectional view to show that the two rails of the bicycle seat are clamped by the adjustable device of the present invention;

FIG. 5a shows a side cross sectional view, taken along line A-B in FIG. 4, wherein the transverse tube and the two rails are located at a first position, and

FIG. 5b shows a side cross sectional view, taken along line A-B in FIG. 4, wherein the transverse tube and the two rails are located at a second position.

### DETAILED DESCRIPTION OF THE PREFERRED EMBODIMENT

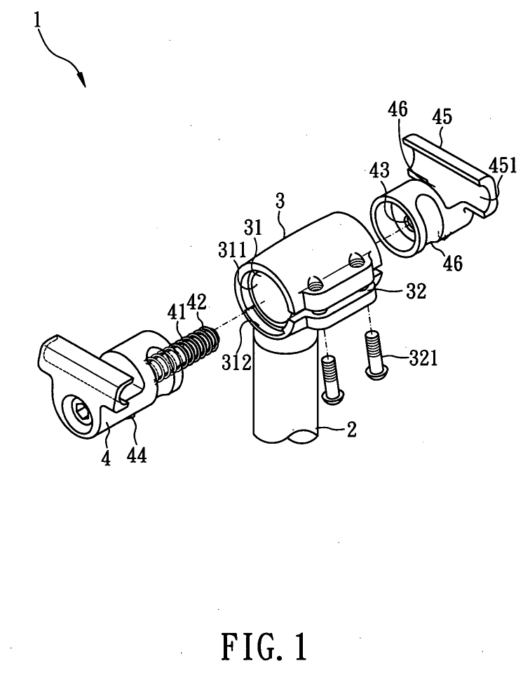

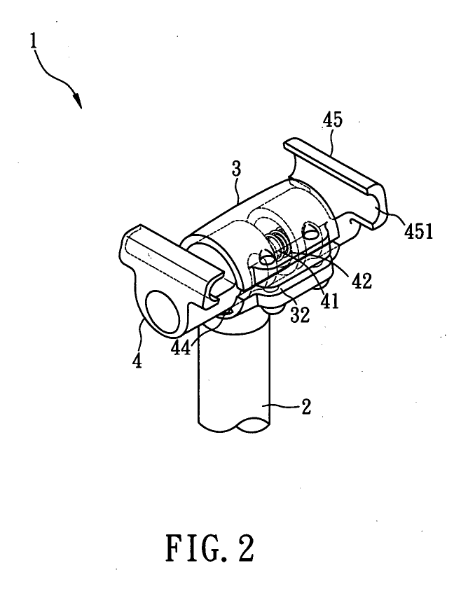

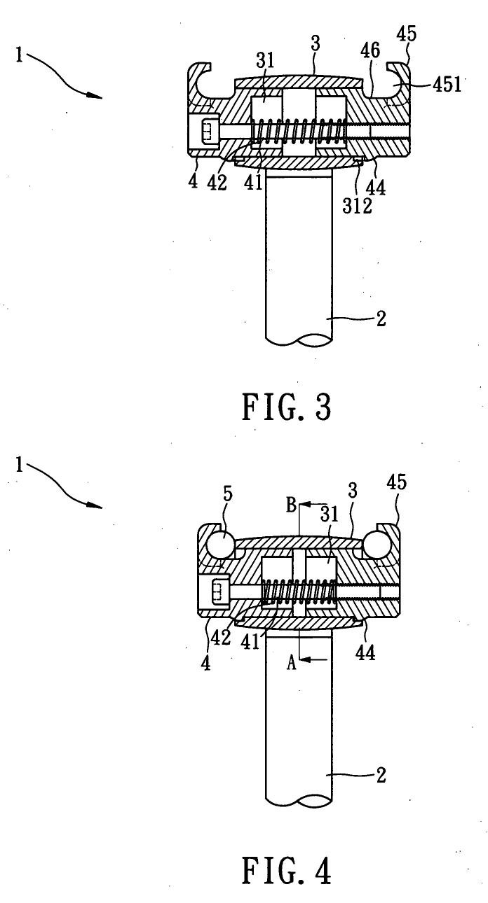

Referring to FIGS. 1 to 3, the bicycle seat adjustable device 1 of the present invention comprises a seat post and a transverse tube 3 is connected on a top end of the seat post. A lower end of the seat post is connected to a seat tube and the transverse tube 3 includes an axial passage 31 and two open ends 311 which communicate with the passage 31. Two notches 312 are defined radially in respective two inner peripheries of the two open ends 311 respectively. The transverse tube 3 includes an axial slot 32 defined through a wall thereof and two flanges extend from two ends of the axial slot 32. Two bolts 321 extend through one of the flanges and are threaded connected to the other flange so as to narrow the axial slot 32.

Two adjustable members 4 are connected to the two open ends 311 of the transverse tube 3 and each of the two adjustable members 4 includes a tubular portion which is inserted into the passage 31 via the open end 311 corresponding thereto. One of the adjustable members 4 has an adjustable bolt 41 extending from one end thereof and the other adjustable member includes a threaded hole 43 in which the adjustable bolt 41 is connected, such that when rotating the adjustable bolt 41, the two adjustable members 4 are moved toward each other or away from each other. A spring 42 is mounted to the adjustable bolt 41 and biased between two facing ends of the two adjustable members 4. By the spring 42, the user can adjust the connection between the two adjustable members 4 and the transverse tube 3. The two bolts 321 can narrow the axial slot 32 to let the transverse tube 3 securely clamp the two tubular portions of the two adjustable members 4. Each adjustable member 4 has a protrusion 44 extending outward and radially therefrom and engaged with the one of the two notches 312 of the transverse tube 3.

Each of the notches 312 is longer than the protrusion 44 received therein so that the protrusion 44 is slid within the notch 312 and the notches 312 restrict the travel of the protrusions 44 therein. Of course, each of the notches 312 can also be sized the same as the protrusion 44 so that the protrusion 44 is securely positioned in the notch 312.

Further referring to FIG. 4, the two adjustable members 4 each have a clamp portion 45 extending radially therefrom and each clamp portion 45 includes a groove 451 defined in an inside thereof. Each of the two adjustable members 4 further includes two concavities 46 defined in an outer periphery of the tubular portion thereof and one of the concavities 46 communicates with the groove 451 corresponding thereto. The two concavities 46 can be slightly deformed when connecting the tubular portion to the axial passage 31 of the transverse tube 3. The two rails 5 are engaged with the grooves 451 and clamped between the clamp portions 45 and the two open ends 311 of the transverse tube 3.

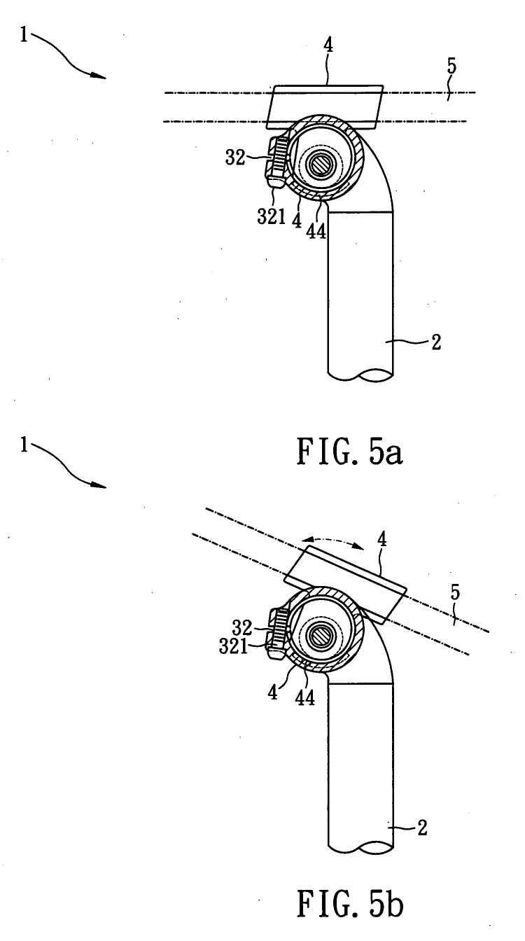

As shown in FIGS. 5a and 5b, the transverse tube 3 can be positioned at the first and second positions as shown, the notches 312 effectively restrict the travel of the protrusions 44 on the two adjustable members 4 such that the seat will not be overly pivoted.

While we have shown and described the embodiment in accordance with the present invention, it should be clear to those skilled in the art that further embodiments may be made without departing from the scope of the present invention.

1. A bicycle seat adjustable device comprising:
a seat post and a transverse tube connected on a top end of the seat post, a lower end of the seat post adapted to be connected to a seat tube, the transverse tube including a passage and two open ends which communicate with the passage, two notches defined radially in respective two inner peripheries of the two open ends respectively, and
two adjustable members connected to the two open ends of the transverse tube, each of the two adjustable members having a tubular portion which is inserted into the passage via the open end corresponding thereto, one of the adjustable members having an adjustable bolt extending from one end thereof and the other adjustable member including a threaded hole in which the adjustable bolt is connected so as to move the two adjustable members toward each other, each adjustable member having a protrusion extending outward and radially therefrom and engaged with the one of the two notches of the transverse tube, two rails being clamped between the two open ends of the transverse tube and the two adjustable members;
wherein each of the notches is longer than the protusion received therein so that the protusion is slid within the notch.

2. The device as claimed in claim 1, wherein the transverse tube includes an axial slot defined through a wall thereof and two flanges extend from two ends of the axial slot, two bolts extend through one of the flanges and are threaded connected to the other flange to narrow a size of the passage to clamp the tubular portions of the two adjustable members.

3. The device as claimed in claim 1, wherein the two adjustable members each have a clamp portion extending radially therefrom and each clamp portion includes a groove defined in an inside thereof, the two rails are engaged with the grooves and clamped between the clamp portions and the two open ends of the transverse tube.

4. The device as claimed in claim 3, each of the two adjustable members includes two concavities defined in an outer periphery of the tubular portion thereof and one of the concavities communicates with the groove.

5. The device as claimed in claim 1, wherein a spring is mounted to the adjustable bolt and biased between two facing ends of the two adjustable members.

6. (canceled)

7. (canceled)
